(19) United States
(12) Patent Application Publication
(10) Pub. No.: US 2018/0182331 A1
(43) Pub. Date: Jun. 28, 2018

(54) METHOD OF CONTROLLING GRAYSCALE BRIGHTNESS AND DEVICE

(71) Applicant: Shenzhen China Star Optoelectronics Technology Co., Ltd., Shenzhen, Guangdong (CN)

(72) Inventors: Fengcheng XU, Shenzhen, Guangdong (CN); Dongsheng GUO, Shenzhen, Guangdong (CN); Dekang ZENG, Shenzhen, Guangdong (CN)

(73) Assignee: Shenzhen China Star Optoelectronics Technology Co., Ltd., Shenzhen, Guangdong (CN)

(21) Appl. No.: 15/311,509

(22) PCT Filed: Sep. 21, 2016
(86) PCT No.: PCT/CN2016/099544

§ 371 Date: Nov. 15, 2016

(30) Foreign Application Priority Data
Jun. 30, 2016 (CN) 201610496024.X

(51) Int. Cl. G09G 3/36

(52) U.S. Cl. CPC G09G 3/3655; G09G 2310/06; G09G 2310/0251; G09G 2300/0876

(57) ABSTRACT

A grayscale brightness control device includes: a reference voltage generation unit, configured to output a reference voltage, a liquid crystal capacitor charging unit configured to receive the reference voltage from the reference voltage generation unit, a charging waveform being generated based on the reference voltage according to a predetermined grayscale brightness of a pixel in a liquid crystal panel, and a liquid crystal capacitor of the pixel is charged using the generated charging waveform during a predetermined time period. The grayscale brightness control device is not complicated even though the liquid crystal panel includes the grayscale brightness at different scales. The use of the low-complexity hardware is good for a cost reduction.

### BACKGROUND

### 1. Field of the Disclosure

The present disclosure relates to the field of a liquid crystal display (LCD), and more particularly, to a method of controlling the grayscale brightness and a device using the method.

### 2. Description of the Related Art

As FIG. 1 shows, in the conventional grayscale brightness control project, a reference voltage is generated by a P-Gamma IC and supplied to a source to drive an R-string inside the source. Afterwards, a resistor voltage divider generates various grayscale voltages (such as V1, V2, and V3). A pixel voltage digital signal is input to drive the source. According to a decoded pixel voltage digital signal, a grayscale voltage passing a digital to analog converter (DAC) is chosen to be correspondingly output.

The charging waveform of the liquid crystal capacitor of the pixel is shown in FIG. 2 when the output grayscale voltage is imposed on the pixel. T1 indicates charging time period. V1, V2, and V3 indicate voltage. The voltages V1, V2, V3 are different. The display effect of the pixel varies with different output grayscale voltages.

Based on the conventional grayscale brightness control project, more modules are needed to push the grayscale voltage to be successfully output. However, the hardware is more complicated under such circumstances, which is harmful to a cost reduction.

### SUMMARY

To improve the inadequacy of the conventional technology, the present disclosure proposes a grayscale brightness control device including the low-complexity hardware.

According to an embodiment of the present disclosure, a grayscale brightness control device includes: a reference voltage generation unit, configured to output a reference voltage, a liquid crystal capacitor charging unit configured to receive the reference voltage from the reference voltage generation unit, a charging waveform being generated based on the reference voltage according to a predetermined grayscale brightness of a pixel in a liquid crystal panel, and a liquid crystal capacitor of the pixel being charged using the generated charging waveform during a predetermined time period.

Optionally, the liquid crystal capacitor charging unit includes: a charging waveform generation unit, formed by a digital programmable capacitor and a resistor, and a digital signal generation unit. The digital programmable capacitor and the resistor form a resistor-capacitor integrated circuit (RC integrated circuit). The received voltage is an input of the RC integrated circuit. The charging waveform is an output of the RC integrated circuit. The digital signal generation unit is configured to determine a digital signal based on the predetermined grayscale brightness and output the determined digital signal to the digital programmable capacitor so that the digital programmable capacitor can output a capacitance value corresponding to the digital signal.

Optionally, the generated charging waveform is an oblique wave.

Optionally, a slope of a climbing portion of the oblique wave corresponds to the capacitance value of the digital programmable capacitor.

Optionally, the greater the slope of the climbing portion of the oblique wave is, the higher the grayscale brightness of the pixel is.

The merit of the grayscale brightness control device proposed by the preferred embodiment of the present disclosure is that the hardware of the grayscale brightness control device is not complicated even though the liquid crystal panel includes the grayscale brightness at different scales. The use of the low-complexity hardware is good for a cost reduction.

These and other features, aspects and advantages of the present disclosure will become understood with reference to the following description, appended claims and accompanying figures.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a grayscale brightness control device according to a related art.

FIG. 2 illustrates waveforms of charging signal outputting by the related art grayscale brightness control device.

FIG. 3 is a block diagram of a grayscale brightness control device according to one preferred embodiment of the present disclosure.

FIG. 4 is a block diagram of the liquid crystal capacitor charging unit according to the preferred embodiment of the present disclosure.

FIG. 5 is a block diagram of the charging waveform generation unit according to the preferred embodiment of the present disclosure.

FIG. 6 illustrates waveforms of charging signal outputting by the grayscale brightness control device according to the preferred embodiment of the present disclosure.

FIG. 7 is a flowchart of a method of controlling grayscale brightness according to the preferred embodiment of the present disclosure.

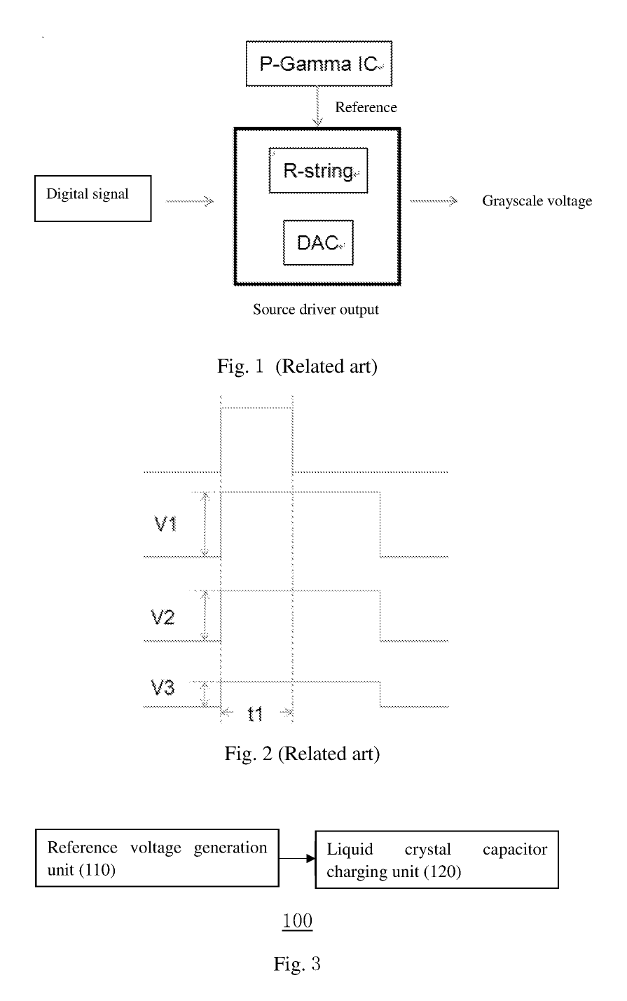

### DETAILED DESCRIPTION OF THE PREFERRED EMBODIMENTS

For better understanding embodiments of the present disclosure, the following detailed description taken in conjunction with the accompanying drawings is provided. Apparently, the accompanying drawings are merely for some of the embodiments of the present invention. Any ordinarily skilled person in the technical field of the present invention could still obtain other accompanying drawings without use laborious invention based on the present accompanying drawings.

FIG. 3 is a block diagram of a grayscale brightness control device 100 according to one preferred embodiment of the present disclosure.

The grayscale brightness control device 100 includes a reference voltage generation unit 110 and a liquid crystal capacitor charging unit 120.

The reference voltage generation unit 110 is used to output a reference voltage.

The liquid crystal capacitor charging unit 120 is used to receive the reference voltage from the reference voltage generation unit 110. A charging waveform is generated based on the received reference voltage according to the predetermined grayscale brightness of the pixel in the liquid crystal panel. Besides, the liquid crystal capacitor of the pixel is charged using the generated charging waveform during a predetermined time period.

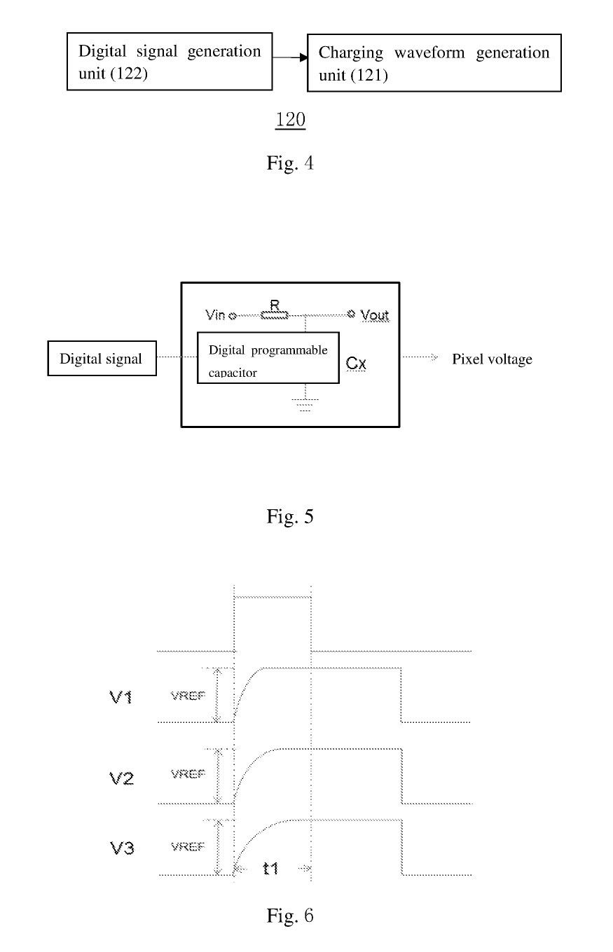

FIG. 4 is a block diagram of the liquid crystal capacitor charging unit 120 according to the preferred embodiment of the present disclosure.

The liquid crystal capacitor charging unit 120 includes a charging waveform generation unit 121 and a digital signal generation unit 122.

The charging waveform generation unit 121 is formed by a digital programmable capacitor and a resistor. The digital programmable capacitor and the resistor form a resistor-capacitor integrated circuit (RC integrated circuit). The received reference voltage is an input of the RC integrated circuit, and the charging waveform is an output of the RC integrated circuit.

The digital signal generation unit 122 is used to determine a digital signal based on the predetermined grayscale brightness and output the determined digital signal to the digital programmable capacitor. Afterwards, the digital programmable capacitor outputs a capacitance value corresponding to the digital signal.

The generated charging wavelength is an oblique wave. The oblique wave is a waveform formed by a climbing portion and a stable portion.

The slope of the climbing portion of the oblique wave corresponds to a capacitance value of the digital programmable capacitor. That is, the slope of the climbing portion of the oblique wave varies with the variation of the capacitance value of the digital programmable capacitor.

The greater the slope of the climbing portion of the oblique wave is, the higher the grayscale brightness of the pixel is.

FIG. 5 is a block diagram of the charging waveform generation unit 121 according to the preferred embodiment of the present disclosure.

The digital signal is input to the digital programmable capacitor Cx. Afterwards, the digital programmable capacitor Cx outputs a corresponding capacitance value C. The resistor R and the digital programmable capacitor Cx form a RC integrated circuit. Vin indicates the input terminal of the RC integrated circuit and receives the reference voltage from the reference voltage generation unit 110. Vout indicates the output terminal of the RC integrated circuit and outputs a charging waveform for the liquid crystal capacitor of the pixel.

The waveform of the reference voltage changes after the reference voltage passes through the RC integrated circuit. When the capacitance value C of the digital programmable capacitor Cx varies according to the digital signal, the climbing time of the voltage and the output charging waveform both are different.

As FIG. 6 shows, the voltage imposed on the capacitor cannot mutate during the former part of the charging time period t1 so the charging voltage gradually rises during the climbing process. Under the circumstances where the voltage imposed on the stable portion of the charging waveform is constant, the capacitance value C of the digital programmable capacitor Cx can achieve different effects according to different grayscale voltages by controlling the climbing state or by controlling the charging voltage for the liquid crystal capacitor of the pixel.

For example, when the liquid crystal capacitor of the pixel is charged with a charging voltage V1, a charging voltage V2, and a charging voltage V3, the grayscale brightness of the pixel is the highest for the charging voltage V1, the next highest for the charging voltage V2, and the lowest for the charging voltage V3.

Although the voltage imposed on the stable portion is constantly the reference voltage with the charging voltages V1, V2, V3, the slope of the climbing portion is the highest for the charging voltage V1, the next highest for the charging voltage V2, and the lowest for the charging voltage V3. Under these circumstances, the grayscale brightness of the pixel ranks the highest for the charging voltage V1, the next highest for the charging voltage V2, and the highest for the charging voltage V3.

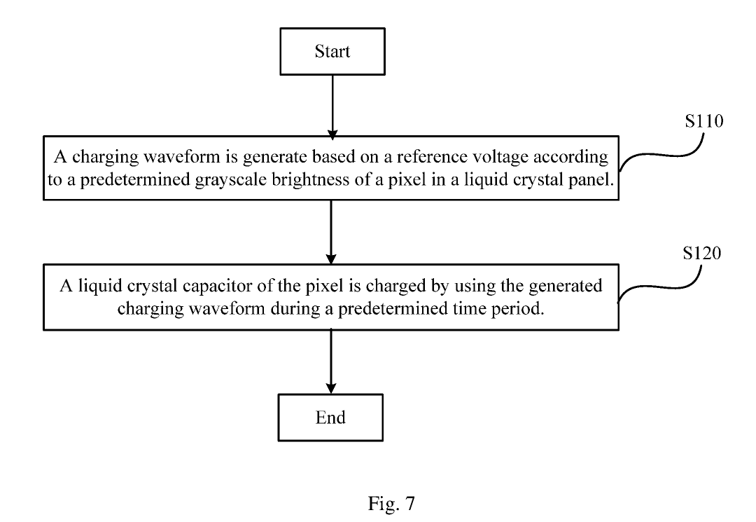

FIG. 7 is a flow chart of a method of controlling the grayscale brightness according to one preferred embodiment of the present disclosure. The method includes steps as follows:

Step 110: A charging waveform is generate based on a reference voltage according to a predetermined grayscale brightness of a pixel in a liquid crystal panel.

In the embodiment, a resistor-capacitor integrated circuit (RC integrated circuit) is used to generate the charging waveform. The RC integrated circuit is formed by a digital programmable capacitor and a resistor. An input of the RC integrated circuit is the reference voltage. An output of the RC integrated circuit is the charging waveform. A digital signal is determined based on the predetermined grayscale brightness. A capacitance value of the digital programmable capacitor in the RC integrated circuit is controlled based on the determined digital signal.

Step 120: A liquid crystal capacitor of the pixel is charged by using the generated charging waveform during a predetermined time period.

Optionally, the generated charging waveform is an oblique wave.

Optionally, a slope of a climbing portion of the oblique wave corresponds to the capacitance value of the digital programmable capacitor.

Optionally, the greater the slope of the climbing portion of the oblique wave is, the higher the grayscale brightness of the pixel is.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A grayscale brightness control device, comprising:
a reference voltage generation unit, configured to output a reference voltage;
a liquid crystal capacitor charging unit, configured to receive the reference voltage from the reference voltage generation unit; a charging waveform being generated based on the reference voltage according to a predetermined grayscale brightness of a pixel in a liquid crystal panel; a liquid crystal capacitor of the pixel being charged using the generated charging waveform during a predetermined time period.

2. The grayscale brightness control device of claim 1, wherein the liquid crystal capacitor charging unit comprises:
a charging waveform generation unit, formed by a digital programmable capacitor and a resistor; the digital programmable capacitor and the resistor forming a resistor-capacitor integrated circuit (RC integrated circuit); the received voltage being an input of the RC integrated circuit; the charging waveform being an output of the RC integrated circuit;
a digital signal generation unit, configured to determine a digital signal based on the predetermined grayscale brightness and output the determined digital signal to the digital programmable capacitor so that the digital programmable capacitor can output a capacitance value corresponding to the digital signal.

3. The grayscale brightness control device of claim 1, wherein the generated charging waveform is an oblique wave.

4. The grayscale brightness control device of claim 3, wherein a slope of a climbing portion of the oblique wave corresponds to the capacitance value of the digital programmable capacitor.

5. The grayscale brightness control device of claim 3, wherein the greater the slope of the climbing portion of the oblique wave is, the higher the grayscale brightness of the pixel is.

6. A method of controlling grayscale brightness, comprising:
generating a charging waveform based on a reference voltage according to a predetermined grayscale brightness of a pixel in a liquid crystal panel;
charging a liquid crystal capacitor of the pixel using the generated charging waveform during a predetermined time period.

7. The method of claim 6, wherein a step of generating the charging waveform based on the reference voltage comprises:
using a resistor-capacitor integrated circuit (RC integrated circuit) to generate the charging waveform;
wherein the RC integrated circuit is formed by a digital programmable capacitor and a resistor; an input of the RC integrated circuit is the reference voltage; an output of the RC integrated circuit is the charging waveform,
wherein a digital signal is determined based on the predetermined grayscale brightness; a capacitance value of the digital programmable capacitor in the RC integrated circuit is controlled based on the determined digital signal.

8. The method of claim 6, wherein the generated charging waveform is an oblique wave.

9. The method of claim 8, wherein a slope of a climbing portion of the oblique wave corresponds to the capacitance value of the digital programmable capacitor.

10. The method of claim 8, wherein the greater the slope of the climbing portion of the oblique wave is, the higher the grayscale brightness of the pixel is.
